(19) United States
(12) Patent Application Publication
(10) Pub. No.: US 2008/0309965 A1
(43) Pub. Date: Dec. 18, 2008

(54) Apparatus and method for discovering printers within an enterprise

(75) Inventor: Marvin Scaff, Tampa, FL (US)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: DEX IMAGING

(21) Appl. No.: 11/812,017

(22) Filed: Jun. 14, 2007

(51) Int. Cl. G06F 3/12

(52) U.S. Cl. 358/1.15

(57) ABSTRACT

The invention relate to an apparatus and a method for determining printer usage of all printers in an enterprise to generate accurate sales proposals. The method includes assigning an account for the enterprise and executing a network scan on a computer network to obtain information for all printers attached to the computer network. The method also includes executing a local scan on each computer that is attached to a non-network printer to obtain information for all non-network printers in the enterprise and executing a port scan to obtain information for all non-catalogued printers. The method further includes storing all of the information obtained from executing the network scan, the local scan and the port scan and performing each of the steps above at least during two predetermined times. The method also includes using the information to generate sales proposals for all printer usage within the enterprise.

### BACKGROUND OF THE INVENTION

1. Field of the Invention

The present invention relates to an apparatus and method for discovering printers within an enterprise and for collecting a representative sample of printer usage within the enterprise to accurately generate sales proposals.

2. Description of the Related Art

Computer networks in an enterprise/organization typically include computer systems and peripherals, such as printers, connected to the computer systems. Organizations rely on printers for carrying out daily operations. An inoperative printer, due to failure or to the lack of consumable components such as toner, can disrupt operations, and waste time and resources. Thus, organizations often desire to determine the extent of usage of printers to prevent disruptions.

Computer networks typically include network printers that are connected directly to the computer network, such that the network printers may be shared by multiple users. Computer networks may also include multiple non-network printers that are connected to one or more individual computers, such that the non-network printers are used by only the computers to which it is connected. Due to the fact that non-network printers are not directly accessible via the computer network, contemporary methods of usage monitoring over the network are not applicable.

Usage of a printer is typically determined by the page count. Pages can be counted manually by sending service personnel to each printing device to procure the page counts via typical means, such as executing a printer test page. This procedure requires a considerable amount of manpower and is costly. Additionally, this procedure can be inaccurate due to human errors. One contemporary attempt to provide more accuracy in monitoring printer usage employs the counting of power surges at the printer to determine the number of pages printed. This method requires that every printer utilizes a stepper motor to advance sheets of paper during printing. Pulsing of each of the coils of the stepper motor results in pulses in the supply current which is to be detected by a separate detection circuit. The detection circuit is operably connected to both a power supply of the printer and a data collection unit. This method suffers from the drawback of being limited to particular types of printers, as well as, inaccuracies in attempting to detect power surges caused only by the coils of the stepper motor during printing. This method suffers from the further drawback of requiring costly hardware for every printer in order to detect the power surges and transmit data representative of the power surges for calculation of the printer usage.

Additionally, contemporary systems that rely on only print counts, do not account for fluctuations in the use of consumable components, such as ink or toner. Usage of consumable components is typically dependent on the type of print job that has occurred. In environments that perform large print jobs, the necessity to re-print the job because of an inadequate amount of ink, resulting in a poor quality of the print job, can be time consuming and costly. It is undesirable to replace consumable components during busy print times, especially where particular print-jobs are time sensitive. Attempting to estimate consumption of consumable components based upon printer usage is usually inaccurate for the reasons described above. Supplies for such consumable components can take time to procure resulting in further disruptions. However, over-estimates of usage of the consumable component is also costly.

In order to accurately service all of the printers within the enterprise, there is a need to accurately determine the usage of both network and non-network printers. There are currently monitoring systems for monitoring the usage of network printers. However, these systems typically cannot discover non-network printers. While there are also monitoring systems that monitor the usage of non-network printers, these systems have been unable to accurately count prints and monitor printer usage on computers that are attached to two or more non-network printers. For example, if a computer system is attached to non-network printers and the computer executes a print command for multiple duplicate print batches, for example, five copies of a five page document, these systems typically count the number of copies printed for that print command as five pages instead of twenty five pages. These systems also cannot monitor ink usage for non-network printers effectively. Therefore, these systems do not accurately report when ink cartridges need to be changed and/or the amount of ink remaining in a currently used ink cartridge.

For a printer service provider to effectively service all of the printers within an enterprise, an accurate sales proposal needs to be generated in order to the printer service provider to deliver satisfactory customer service. Sales proposals are currently based on a manually collected list for each of the printers with the enterprise. Thereafter, a sales person generates a sales proposal by estimating the total usage of each printer. The manually collected data is typically inaccurate due to improper collection methods or underestimation of future print usages by the sale person. Thus, this process is inherently flawed.

What is needed, therefore, is a process of collecting accurate data on printer usage for both network and non-network printers within an enterprise in order to standardize sales proposals and generate accurate sales proposals that meet client's expectations.

### SUMMARY

The present invention is directed to a method for determining printer usage of all printers in an enterprise to generate accurate sales proposals. The method includes assigning an account for the enterprise and executing a network scan on a computer network to obtain information for all printers attached to the computer network. The method also includes executing a local scan on each computer that is attached to a non-network printer to obtain information for all non-network printers in the enterprise and executing a port scan to obtain information for all non-catalogued printers. The method further includes storing all of the information obtained from executing the network scan, the local scan and the port scan and performing each of the steps above at least during two predetermined times. The method also includes using the information to generate sales proposals for all printer usage within the enterprise.

Another embodiment of the invention is directed to a system for determining printer usage of all printers in an enterprise to generate accurate sales proposals. The system includes a monitoring unit installed on each computer which is attached to a non-network printer. The system also includes an assignment unit configured to assign an account for the enterprise. The system further includes a discovery unit configured to execute a network scan on a computer network to obtain information for all printers attached to the computer network, to execute a local scan on each computer that is attached to a non-network printer to obtain information for all non-network printers in the enterprise and to execute a port scan to obtain information for all non-catalogued printers. The system also includes a storage unit configured to store all of the information obtained from executing the network scan, the local scan and the port scan and a generation unit configured to use the information to generate sales proposals for all printer usage within the enterprise.

Another embodiment of the invention is directed to an apparatus for determining printer usage of all printers in an enterprise to generate accurate sales proposals. The apparatus includes assigning means for assigning an account for the enterprise and executing means for executing a network scan on a computer network to obtain information for all printers attached to the computer network. The apparatus also includes executing means for executing a local scan on each computer that is attached to a non-network printer to obtain information for all non-network printers in the enterprise and executing means for executing a port scan to obtain information for all non-catalogued printers. The apparatus further includes storing means for storing all of the information obtained from executing the network scan, the local scan and the port scan, performing means for performing each of the steps above at least during two predetermined times and using means for using the information to generate sales proposals for all printer usage within the enterprise.

Another embodiment of the invention is directed to a computer program embodied on a computer readable medium, the computer program includes program code for controlling a processor to execute a method for determining printer usage of all printers in an enterprise to generate accurate sales proposals. The method includes assigning an account for the enterprise, executing a network scan on a computer network to obtain information for all printers attached to the computer network, executing a local scan on each computer that is attached to a non-network printer to obtain information for all non-network printers in the enterprise, executing a port scan to obtain information for all non-catalogued printers, storing all of the information obtained from executing the network scan, the local scan and the port scan, performing each of the steps above at least during two predetermined times and using the information to generate sales proposals for all printer usage within the enterprise.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1 illustrates an embodiment of a computer network in which embodiments of the present invention may be implemented; and

FIG. 2 illustrates the steps implemented in embodiment of the present invention.

### DETAILED DESCRIPTION OF PREFERRED EMBODIMENTS

Reference will now be made to the preferred embodiments of the present invention, examples of which are illustrated in the accompanying drawings.

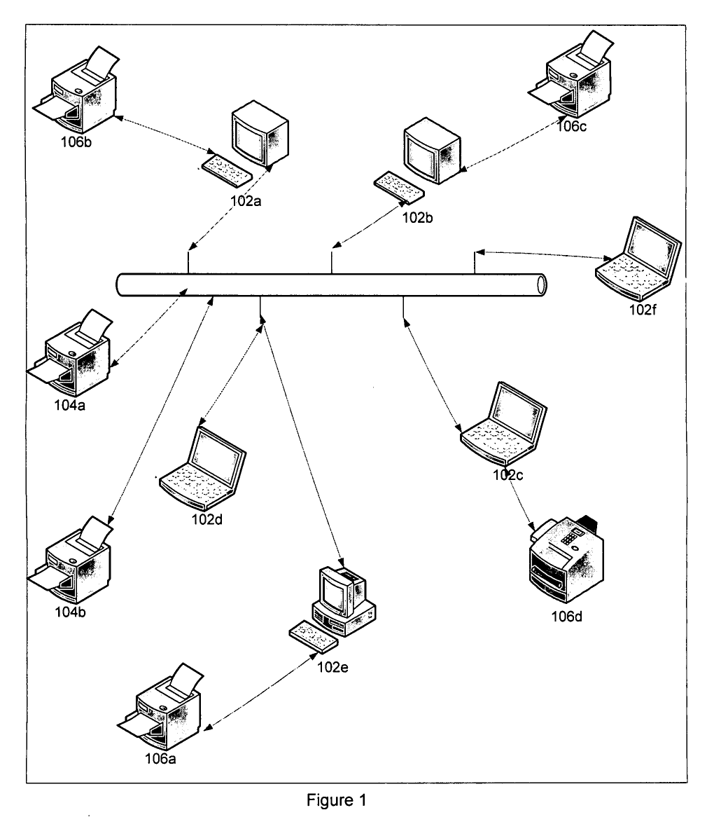

FIG. 1 illustrates an embodiment of a computer network in which embodiments of the present invention may be implemented. The computer network includes multiple computers 102, each of which is connected to the computer network by standard computer networking methods. The computer network also includes multiple network printers 104a-104b and multiple non-network printers 106a-106d. Each of the non-network printers is only used by the computer to which it is connected. For example, non-network printer 106a is only used by computer 102e, non-network printer 106b is only used by computer 102a and non-network printer 106c is only used by computer 102b. As is apparent to one of ordinary skill in the art, the configuration of the computer network may be modified and still remain within the scope of the present invention.

In an exemplary embodiment, a system or process is provided that can consolidate printing status information from multiple locations. Reporting of the printing status information can be done in real time, although the present disclosure contemplates utilization of other timing schemes for data transfer, for example, polling. Thus, in the exemplary embodiment of the present invention, detection, consolidation and mitigation of service issues across multiple locations can be accomplished. The exemplary embodiment is capable of monitoring and maintaining both networked and non-networked printers so that the entire organization's printing needs are serviced.

Furthermore, an embodiment of the invention accurately tracks duplicate print batches executed a non-networked printer. The embodiment of the invention also monitors the resources for each of the printers. For example, components used in an embodiment of the invention is capable of determining whether ink cartridges have been replaced or the amount of usage left in the cartridge before replacement is required.

A non-shared desktop printer (NSDP) local agent application is installed on each of the computers, for example 102a, 102b and 102e, that is connected to at least one non-network printers 106. The NSDP local agent application may monitor and maintain multiple non-networked printers 106 connected to a single computer. Specifically, the NSDP local agent application is capable of uniquely identifying each of non-network printers 106. In one embodiment, each of the non-network printers is identified through a combination of make, model and Media Access Control (MAC) address associated with the non-network printer. The present disclosure contemplates the use of other indicia for identification of each of non-network printer.

The NSDP local agent application has a desktop machine component and a location server component. The desktop machine component includes an application programming interface (API) or other source code interface to support requests for services, an intermediate level interface and an upper level interface. The API extracts data related to the non-networked printers 106. The intermediate layer is preferably a Java Native Interface (JNI) that allows Java code running in a Java virtual machine to call and be called by native applications, for example, programs specific to hardware and operating system platforms and libraries written in other languages, including Visual C++. The intermediate level interface may receive the data from API layer. The upper layer interface is preferably a Remote Method Invocation (RBI) client layer which is a protocol that allows a computer program running on one computer to cause a subroutine another computer to be executed without a programmer explicitly coding the details for this interaction. The RBI client layer may point to an RMI service running on an external location server.

In an embodiment of the invention, at pre-determined time intervals, a daemon or the like can be used to invoke the RMI client layer to communicate data from the computer, for example 102a, 102b and 102e connected to non-network printer 106, to the external location server. A property file and the like may be used for storing characteristics pertaining to the external location server to facilitate and/or enable communication with the location server. At each pre-determined time, after the NSDP local agent application confirms that the external location server is operating, it sends data for each non-network printer 106 to the external location server.

The location server component of the NSDP local agent application may include a RMI service and an XML data source. The external location server may utilize a separate process in order to accommodate NSDP scanning and meter reading. The RMI service may expose a single method that receives data from various printers.

Thus, the NSDP local agent application enables the API layer to communicate with the registry of the computer, for example 102a, 102b and 102e connected to a non-network printer 106, to obtain information regarding the locally connected printers. The NSDP local agent application obtains printer usage data, meter reads or page counts where available from printers 106. Where the particular type of printer does not provide for page counts, NSDP local agent application invokes a job listener to obtain such data. The job listener includes a data listener file locally on each computer, connected to a non-network printer 106. The data listener enables each printer 106 to perform the page count operation. The job listener tracks each page printed after the installation of the NSDP local agent application and increments the page count data in the data listener file accordingly.

The NSDP local agent application also obtains data regarding the toner or ink cartridge status or other consumable resource of each of printers 106 through the job listener, which updates a resource status in the data listener file. A polling technique can be utilized to obtain the resource status from the data stored in the data listener file. The frequency of the polling can be varied depending upon printer usage. An indication of a low toner or other need for a resource replacement can be communicated to the computer, for example 102a, 102b and 102e, for replacement of the consumable resource prior to deterioration of the quality of the print jobs.

In order to accurately determine printer usage in the computer network, the NSDP local agent application is installed on each of the computers, for example 102a, 102b and 102e, that is connected to a non-network printer 106. Upon installing the NSDP local agent application, a unique key is generated for later implementing a discovery application. Thus, the discovery application may only be executed after it has been specifically authorized, that is after the unique key has been generated. By limiting the execution of the discovery application to authorized executions only, information collected and communicated to the printer service provider is protected, thereby protecting the security of a client's network and the security of the client's data gathered by the discovery application. Communications between the printer service provider and the client's computer network are secured and protected by using, for example https and SSL.

Thereafter, the discovery application is executed on the computer connected to the non-network printer 106, for example, by inserting a USB drive/key in a USB slot on the computer. The discovery application runs through every IP address on the network and identifies IP addresses to which printers are attached. The discovery application also identifies information such as, the model, the description, the type of computer and the manufacture of the computer associated with the IP address. The discovery application identifies the page count associated with each printer, that is page count for both network and non-network printers. The information identified by the discovery application is collected and stored into an external database at the printer service provider. At some predetermined point, for example two weeks later, the discovery application is rerun. As a result the printer service provide has two data points from which it can extrapolate overall enterprise printer usage and build a proposal for a prospective client.

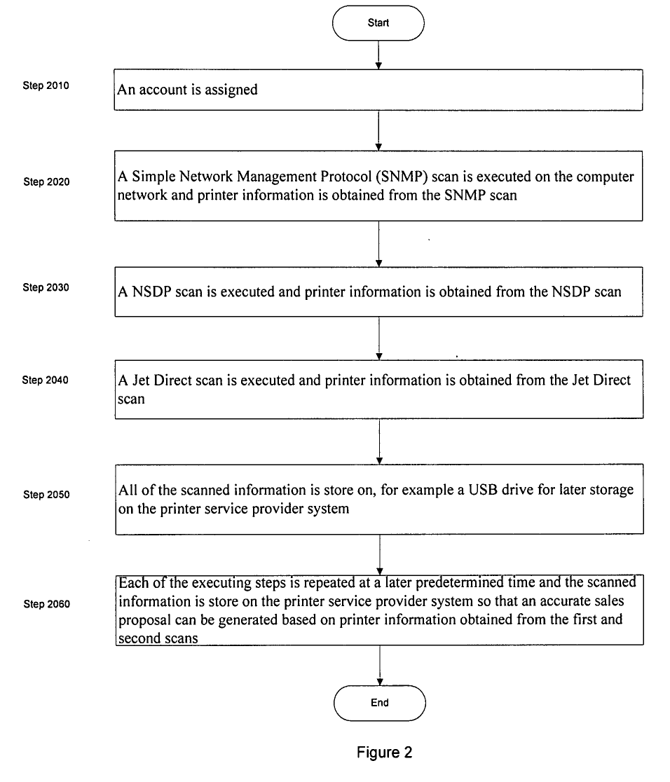

FIG. 2 illustrates the steps implemented in embodiment of the present invention. In step 2010, an account is assigned, wherein a scan type is set. A sales person may thereafter use the account to take notes about a prospective client. These notes may be edited at a later time. In Step 2020, a Simple Network Management Protocol (SNMP) scan is executed on the computer network and printer information is obtained from the SNMP scan. Specifically, the SNMP scan obtains all available IP addresses for each printer attached to the computer and obtains information such as the print count associated with the computer. The SNMP scan enables the discovery application to obtain information for the majority of printers on the network and enables the discover application to obtain complete. MIB information on those printers.

In Step 2030, a NSDP scan is executed and printer information is obtained from the NSDP scan. Specifically, the NSDP scan obtains the IP addresses for all NSDP agents and the information provided by the NSDP agent about the printers connected to the NSDP agent. The NSDP scan is enables the discovery application to obtain information from the printers that were not discovered in the SNMP scan. Specifically, the NSDP scan enables the discovery application to obtain information from non-network printers that are connected to individual computers rather than to the computer network. In Step 2040, a Jet Direct scan is executed and printer information is obtained from the Jet Direct scan. Specifically, the Jet Direct scan sends a query to a specific port, for example port 9001, to obtain information for non-catalogued enterprise printers connected to the client network. In Step 2050, all of the scanned information is store on, for example a USB drive for later storage on the printer service provider system. In Step 2060, each of the executing steps is repeated at a later predetermined time and the scanned information is store on the printer service provider system so that an accurate sales proposal can be generated based on printer information obtained from the first and second scans.

During the steps implemented in FIG. 2, the present invention accurately counts and monitors computer/printer configurations when there are multiple non-network desktop printers attached to one computer and when there are computers attached to a non-network printer have executed multiple duplicate print batches to be printed, for example five copies of a multi-page document.

It should be appreciated by one skilled in art, that the present invention may be utilized in any computer network configuration where there are non-network and network printers, as described above. The foregoing description has been directed to specific embodiments of this invention. It will be apparent; however, that other variations and modifications may be made to the described embodiments, with the attainment of some or all of their advantages. Therefore, it is the object of the appended claims to cover all such variations and modifications as come within the true spirit and scope of the invention.

What is claimed:

1. A method for determining printer usage of all printers in an enterprise to generate accurate sales proposals, comprising:
assigning an account for the enterprise;
executing a network scan on a computer network to obtain information for all printers attached to the computer network;
executing a local scan on each computer that is attached to a non-network printer to obtain information for all non-network printers in the enterprise;
executing a port scan to obtain information for all non-catalogued printers;
storing all of the information obtained from executing the network scan, the local scan and the port scan;
performing each of the steps above at least during two predetermined times; and
using the information to generate sales proposals for all printer usage within the enterprise.

2. The method of claim 1, wherein the network scan is a simple network management protocol scan.

3. The method of claim 1, wherein executing the network scan comprises obtaining an internet protocol address and print status information for each printer in the computer network.

4. The method of claim 1, wherein executing the local scan comprises obtaining an internet protocol address for each print monitoring agent and obtaining print status information from each print monitoring agent.

5. The method of claim 1, where executing the port scan comprises sending a query to a specific port to obtain information on non-catalogued printers.

6. The method of claim 1, further comprising generating a unique key prior to assigning an account for the enterprise.

7. The method of claim 6, further comprising enabling the executing steps only after the unique key is generated.

8. A system for determining printer usage of all printers in an enterprise to generate accurate sales proposals, comprising:
a monitoring unit installed on each computer which is attached to a non-network printer
an assignment unit configured to assign an account for the enterprise;
a discovery unit configured to execute a network scan on a computer network to obtain information for all printers attached to the computer network, to execute a local scan on each computer that is attached to a non-network printer to obtain information for all non-network printers in the enterprise and to execute a port scan to obtain information for all non-catalogued printers;
a storage unit configured to store all of the information obtained from executing the network scan, the local scan and the port scan; and
a generation unit configured to use the information to generate sales proposals for all printer usage within the enterprise.

9. The system of claim 8, wherein the network scan is a simple network management protocol scan.

10. The system of claim 8, wherein the discovery unit is configured to obtain an internet protocol address and print status information for each printer in the computer network during the network scan.

11. The system of claim 8, wherein the discovery unit is configured to obtain an internet protocol address for each print monitoring agent and obtaining print status information from each print monitoring agent during the local scan.

12. The system of claim 8, wherein the discovery unit is configured to obtain send a query to a specific port to obtain information on non-catalogued printers during the port scan.

13. The system of claim 8, further comprising generating unit configured to generate a unique key prior to assigning an account for the enterprise.

14. The system of claim 13, wherein execution of the discovery unit is enabled only after the unique key is generated.

15. An apparatus for determining printer usage of all printers in an enterprise to generate accurate sales proposals, comprising:
assigning means for assigning an account for the enterprise;
executing means for executing a network scan on a computer network to obtain information for all printers attached to the computer network;
executing means for executing a local scan on each computer that is attached to a non-network printer to obtain information for all non-network printers in the enterprise;
executing means for executing a port scan to obtain information for all non-catalogued printers;
storing means for storing all of the information obtained from executing the network scan, the local scan and the port scan;
performing means for performing each of the steps above at least during two predetermined times; and
using means for using the information to generate sales proposals for all printer usage within the enterprise.

16. The apparatus of claim 15, wherein the network scan is a simple network management protocol scan.

17. The apparatus of claim 15, wherein the executing means for executing the network scan comprises obtaining means for obtaining an internet protocol address and print status information for each printer in the computer network.

18. The apparatus of claim 15, wherein executing means for executing the local scan comprises obtaining means for obtaining an internet protocol address for each print monitoring agent and obtaining print status information from each print monitoring agent.

19. The apparatus of claim 15, where executing means for executing the port scan comprises sending means for sending a query to a specific port to obtain information on non-catalogued printers.

20. The apparatus of claim 15, further comprising generating means for generating a unique key prior to assigning an account for the enterprise.

21. The apparatus of claim 20, further comprising enabling the executing steps only after the unique key is generated.

22. A computer program embodied on a computer readable medium, the computer program comprising program code for controlling a processor to execute a method for determining printer usage of all printers in an enterprise to generate accurate sales proposals, comprising:
assigning an account for the enterprise;
executing a network scan on a computer network to obtain information for all printers attached to the computer network;
executing a local scan on each computer that is attached to a non-network printer to obtain information for all non-network printers in the enterprise;
executing a port scan to obtain information for all non-catalogued printers;
storing all of the information obtained from executing the network scan, the local scan and the port scan;
performing each of the steps above at least during two predetermined times; and
using the information to generate sales proposals for all printer usage within the enterprise.
